(19) United States
(12) Patent Application Publication
(10) Pub. No.: US 2010/0087136 A1
(43) Pub. Date: Apr. 8, 2010

(54) MOBILE COMMUNICATION CANCELLATION METHOD AND APPARATUS

(76) Inventor: MICHAEL F. OYASKI, EBENSBURG, PA (US)

Correspondence Address: James Ray & Associates, 2640 Pitcairn Road, Monroeville, PA, 15146, US

(21) Appl. No.: 12/573,505

(22) Filed: Oct. 5, 2009

Related U.S. Application Data
(60) Provisional application No. 61/195,330, filed on Oct. 6, 2008.

(51) Int. Cl. H04K 3/00

(52) U.S. Cl. 455/1

(57) ABSTRACT

The invention provides a method and apparatus that can at least limit use of mobile communication devices on passenger mass transit vehicles, planes, off-road vehicles, pieces of heavy equipment or machinery when predetermined conditions related to motion of such vehicles, planes, equipment, machinery or at least one component thereof are met.

### CROSS REFERENCE TO RELATED APPLICATION

This patent application is related to and claims priority from U.S. Provisional Patent Application Ser. No. 61/195,330 filed Oct. 6, 2008.

### FIELD OF THE INVENTION

The present invention relates, in general, to mobile communication devices jamming devices and, more particularly, this invention relates to a method and apparatus for preventing an owner from using a cellular telephone in situations when predetermined conditions are met.

### BACKGROUND OF THE INVENTION

The use of cell phones, Personal Digital Assistants and other mobile communication devices proliferated to alarming proportions in recent years. Of a particular concern is use of such mobile devices while driving a vehicle, operating machinery or heavy equipment or in locations where radio frequency (RF) transmission may cause a hazard. While legislative efforts have been passed and/or are being contemplated to curb use of mobile communication devices under these conditions, their actual use continues to grow.

It is generally well known that use of the mobile communication devices under the above conditions has been linked to numerous accidents causing injuries and even fatalities to both users and innocent and unsuspecting members of the public. The concern is particularly felt when the mobile communication devices is being used by a driver/operator of a passenger mass transit vehicle, for example such as a train or a bus, due to a larger percentage of the members of publics being present as compared with a conventional motor vehicle.

Prior to the conception and development of the present invention efforts have been made to prevent transmission from the mobile communication device by essentially jamming the transmission signal when predetermined conditions are met.

However, these efforts have been limited to conventional motor vehicles and have been focused on preventing any transmissions while motor vehicle is in motion. Furthermore, as it is further known emergency conditions arise that require use of the mobile communication devices.

Therefore, there is a continuing need for a method and apparatus that can at least limit the use of mobile communication devices when predetermined conditions are met.

### SUMMARY OF THE INVENTION

The invention provides a method and apparatus that can at least limit use of mobile communication devices on passenger mass transit vehicles, planes, off-road vehicles, pieces of heavy equipment or machinery when predetermined conditions related to motion of such vehicles, planes, equipment, machinery or at least one component thereof are met.

### OBJECTS OF THE INVENTION

It is, therefore, one of the primary objects of the present invention to provide a method and apparatus which will at least limit mobile communication device from being used when predetermined conditions are met.

Another object of the present invention is to provide a method which will at least limit mobile communication devices from being used by a driver of a passenger mass transit vehicle, operator of machinery or heavy equipment, pilot of a commercial or leisure plane, a person located in environment wherein RF transmission may cause a hazard.

Yet another object of the present invention is to provide a method which will at least limit mobile communication devices from being used by a driver of a vehicle while such vehicle is in motion.

A further object of the present invention is to provide a method which will at least limit mobile communication devices from being used by a driver of a vehicle while such vehicle is in motion that will not affect mobile communication device usage by others.

Yet a further object of the present invention is to provide an apparatus that could be mounted in or on a vehicle, machinery or equipment to at least limit use of mobile communication device while such vehicle, machinery or equipment is being operated.

### BRIEF DESCRIPTION OF THE DRAWINGS

FIG. 1 illustrates a schematic diagram of a rail vehicle employing an apparatus of the present invention for at least limiting use of mobile communication devices;

FIG. 2 is a partial side elevation view of an operating cab used on the rail vehicle of FIG. 1;

FIG. 3 illustrates a block diagram of an apparatus of the present invention for at least limiting use of mobile communication devices within the operating cab of FIG. 2;

FIG. 4 is a side elevation view of a piece of machinery having at least one moving component and employing an apparatus of the present invention for at least limiting use of mobile communication devices within a predetermined distance from such piece of machinery; and

FIG. 5 illustrates environmental view of an apparatus of the present invention for at least limiting use of mobile communication devices installed at a gas or fuel filling station.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

It is to be understood that the definition of a mobile communication device includes but is not limited to cell phones, Personal Digital Assistant (PDA), pagers, computers and the like devices capable of emitting and receiving a transmission signal.

The invention will be illustrated and described in combination with a passenger mass transit vehicle, for example such as a train. However, it will be apparent to those skilled in the relevant art that the present invention may be applied to other vehicles, for example an off-road vehicle, pieces of heavy equipment and pieces of machinery having at least one movable component, and as such should not be interpreted as a limiting factor of the apparatus and method of the present invention.

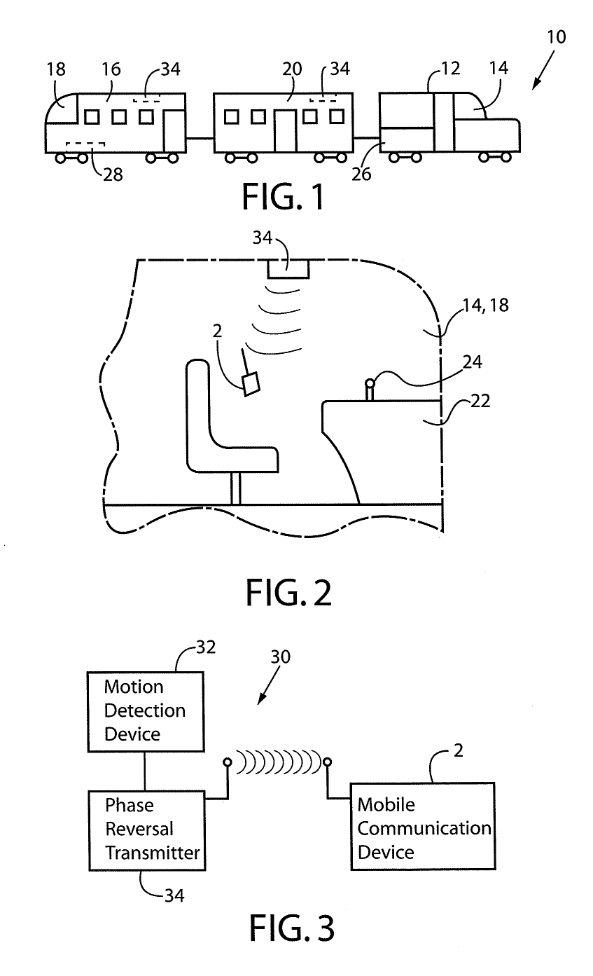

Reference is now made, to FIG. 1, wherein there is shown a train consist, generally designated as 10. Furthermore, such train consist is illustrated as a well known passenger mass transit rail vehicle. Such vehicle generally may consist of a locomotive 12 having an operating cab 14 wherein the operator (driver) of the vehicle may reside. Now in reference to FIG. 2, the operating cab 14 includes operator console 22 and a throttle handle 24 employed to govern the power plant 26. The operating cab 14 will further include additional, gages, indicators, switches and like devices whose description and use is omitted for the sake of brevity.

The passenger mass transit rail vehicle 10 further has what is commonly and conventionally called a cab car 16 which has its own operating cab 18. The internal layout of the operating cab 18 is generally identical to the internal layout of the operating cab 14, particularly relative to the throttle 24. As it is well known, the vehicle 10 can be equally operated from either cab 14, 18 depending on the direction of motion. There is also at least one passenger car 20 typically disposed between the locomotive 12 and the cab car 16. The vehicle 10 illustrated in FIG. 1 is conventionally known as a commuter or intercity vehicle. Alternatively, a second cab car 16 may replace the locomotive 12 in vehicles referred to as a heavy rail vehicle or a light rail vehicle which are electrically driven by way of a propulsion device 28.

An apparatus 30 for at least limiting the operator of a passenger mass transit vehicle 10 from using a mobile communication device 2 while such passenger mass transit vehicle is in one of a forward motion and a reverse motion includes a first means disposed in a first predetermined location on such passenger mass transit vehicle for 10 determining a motion condition of such passenger mass transit vehicle 10 and for generating and transmitting a first signal when such passenger mass transit vehicle 10 is determined to move in one of a forward motion and a reverse motion. The first means may be a sensor 32 sensing the positions of the throttle handle 24 in one of the forward or reversed motions or sensing speed (motion) generated by the propulsion device 28. When the sensor is mounted within the propulsion device 28 it is commonly known as a zero speed sensor. It will be also appreciated that other systems within the passenger mass transit vehicle 10 may provide such first signal. By way of several examples, such first signal may be provided by monitoring brake pressure of a pneumatically operable braking system, by an output from a train control system or by a signal from a wayside mounted equipment.

There is also a phase reversal generator and transmitter 34 disposed on such passenger mass transit vehicle 10 at a second predetermined location for receiving the first signal transmitted by the first means and for generating and transmitting a reverse phase power output signal when the phase reversal generator and transmitter 34 is activated by the first signal. By way of an example of FIG. 2, such phase reversal generator and transmitter 34 may be mounted at a ceiling portion of the cab 14, 18 although other locations are also within the scope of the present invention. The reverse phase power output signal is transmitted for a predetermined radius at least sufficient to at least limit any transmission to and from the mobile communication device 2 within the predetermined radius when the phase reversal transmitter 34 is transmitting the reverse phase power output signal.

Thus, when the phase reversal transmitter 34 receives the first signal indicating a predetermined condition defining that that the passenger mass transit vehicle 10 is in motion, whether forward or reversed, it generates reverse phase power output signal and transmits this signal to cover the area wherein the mobile communication device 2 may be used.

It is important to note that the present invention permits the user of the mobile communication device 2 to call only certain numbers such as in case of an emergency or receive phone calls or text messages from an authorized governing entity, such as a train dispatcher. Thus, vital communication between the operator and the governing entity will be enabled while any other communications will be disabled and prevented. The present invention also contemplates that any communication will be canceled and may not occur while passenger mass transit vehicle 10 is in motion and that such communication may only occur when passenger mass transit the passenger mass transit vehicle 10 stopped moving for example for enabling ingress and egress of passengers. This may further apply not only to the operator of the passenger mass transit vehicle 10 but also to passengers within the passenger car 20 or the cab car 16 which will be then equipped with identical or similar phase reversal transmitters 34.

It will be also apparent to those skilled in the art that the apparatus 30 of the present invention will be suitable in a freight rail vehicle driven by the locomotive 12.

Equally as well, the apparatus 30 of the present invention will be suitable for use in an off-road vehicle, for example such as a farming combine, earth mover, which is not shown but which is well known in the art.

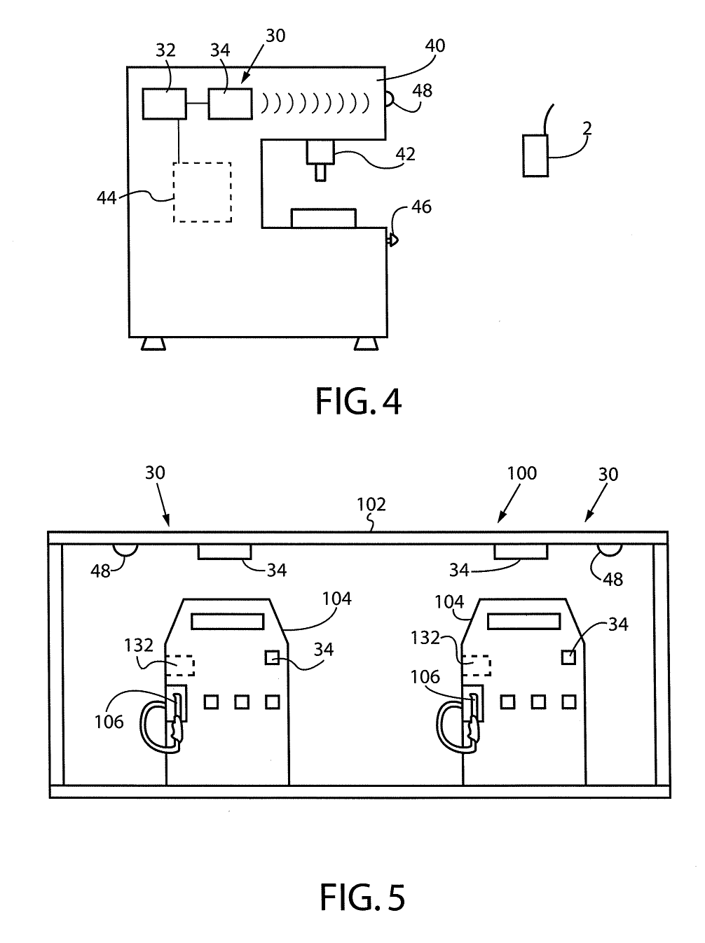

Now in reference to FIG. 4, therein is illustrated the apparatus 30 in combination with a piece of machinery, for example such as a machining device 40 having, for example, a rotating and linearly movable spindle 42 and a controller 44 capable of controlling motion and rotation of the spindle 42 when the switch 46 is activated. The phase reversal transmitter 34 can be then mounted on the exterior surface of such machining device 40 with the sensor 32 coupled to the controller 44 and capable of detecting rotation or motion of the spindle 42. Alternatively, a sensor 48 may be installed, for example on a front portion of the machining device 40 for detecting presence of a person operating such machining device 40. It would be appreciated that the apparatus 30 may be employed on other pieces of the machinery having at least one moving component.

FIG. 5 illustrates use of the apparatus 10 on a gas or fuel filling station, generally designated as 100, that includes at least one gas or fuel pump 104 either freestanding or mounted within a structure 102. The first means may be a sensor 132 located for monitoring position of the nozzle 106 or even a fuel flow. Or, the first means may be the sensor 48 capable of detecting presence of at least of the person and vehicle. The phase reversal transmitter 34 may be affixed to such structure 102, external to the pump 104 or integrated thereinto.

I claim:

1. In a passenger mass transit vehicle a method for at least limiting use of a mobile communication device while such passenger mass transit vehicle is in motion, said method comprises:
(a) determining a speed of such passenger mass transit vehicle;
(b) generating a first signal when such speed of such passenger mass transit vehicle, determined in step (a), exceeds a predetermined speed threshold;
(c) transmitting said first signal, generated in step (b), to means disposed in at least one predetermined location on such passenger mass transit vehicle for generating a reverse phase signal;
(d) generating said reverse phase signal when said first signal, transmitted in step (c), is received by said means for generating said reverse phase signal;
(e) transmitting said reverse phase signal, generated in step (d), for a predetermined radius from such predetermined location; and
(f) at least limiting any transmission from and to said mobile communication device substantially within said predetermined radius while said reverse phase signal is being transmitted in step (e).

2. An apparatus for at least limiting an operator of a passenger mass transit vehicle from using a mobile communication device while such passenger mass transit vehicle is in one of a forward motion and a reverse motion, said apparatus comprising:
(a) a first means disposed in a first predetermined location on such passenger mass transit vehicle for determining a motion condition of such passenger mass transit vehicle and for generating and transmitting a first signal when such passenger mass transit vehicle is determined to move in one of a forward motion and a reverse motion; and
(b) a phase reversal generator and transmitter disposed on such moveable equipment at a second predetermined location for receiving said first signal transmitted by said first means and for generating and transmitting a reverse phase power output signal for a predetermined radius when said phase reversal generator and transmitter is activated by said first signal; wherein said predetermined radius of said reverse phase power output signal from said phase reversal transmitter is at least sufficient to at least limit any transmission to and from said mobile communication device within said predetermined radius when said phase reversal transmitter is transmitting said reverse phase power output signal.

3. An apparatus for at least limiting an operator of a moveable equipment from using a mobile communication device while operating such moveable equipment, said apparatus comprising:
(a) a first means disposed in a first predetermined location on such moveable equipment for determining a motion condition of such moveable equipment and for generating and transmitting a first signal when such moveable equipment is determined to move in one of a forward motion and a reverse motion; and
(b) a phase reversal generator and transmitter disposed on such moveable equipment at a second predetermined location for receiving said first signal transmitted by said first means and for generating and transmitting a reverse phase power output signal for a predetermined radius when said phase reversal generator and transmitter is activated by said first signal; wherein said predetermined radius of said reverse phase power output signal from said phase reversal transmitter is at least sufficient to at least limit any transmission to and from said mobile communication device within said predetermined radius when said phase reversal transmitter is transmitting said reverse phase power output signal.

4. An apparatus for at least limiting a machinery operator from using a mobile communication device while operating such machinery, said apparatus comprising:
(a) a first means disposed in a first predetermined location on such machinery for determining a motion condition of at least one predetermined component disposed within such machinery and for generating and transmitting a first signal when such at least one predetermined component is determined to move in at least one direction; and
(b) a phase reversal generator and transmitter disposed on such moveable equipment at a second predetermined location for receiving said first signal transmitted by said first means and for generating and transmitting a reverse phase power output signal for a predetermined radius when said phase reversal generator and transmitter is activated by said first signal; wherein said predetermined radius of said reverse phase power output signal from said phase reversal transmitter is at least sufficient to at least limit any transmission to and from said mobile communication device within said predetermined radius when said phase reversal transmitter is transmitting said reverse phase power output signal.
